(19) United States
(12) Patent Application Publication
(10) Pub. No.: US 2024/0169710 A1
(43) Pub. Date: May 23, 2024

(54) PROCESSING APPARATUS, PROCESSING METHOD, AND NON-TRANSITORY STORAGE MEDIUM

(71) Applicant: NEC Corporation, Tokyo (JP)

(72) Inventor: Kazuya KAWAKAMI, Tokyo (JP)

(73) Assignee: NEC Corporation, Tokyo (JP)

(21) Appl. No.: 18/505,499

(22) Filed: Nov. 9, 2023

(30) Foreign Application Priority Data
Nov. 18, 2022 (JP) 2022-184614

(51) Int. Cl. G06V 10/776; G06V 10/77; G06V 10/774; G06V 40/10

(52) U.S. Cl. CPC G06V 10/776; G06V 10/7715; G06V 10/774; G06V 40/10

(57) ABSTRACT

To decide validity of results of various types of estimation concerning an involved person in an incident or accident, the present invention provides a processing apparatus 10 including: a site situation information acquisition unit 11 that acquires site situation information indicating a situation of a site; an involved person estimation unit 12 that estimates, based on the site situation information, a feature of an involved person of an event that occurred at the site; a computation unit 13 that computes a feature difference being a difference between the estimated feature of the involved person and a feature of a target person; and an output unit 14 that outputs the feature difference.

This application is based upon and claims the benefit of priority from Japanese patent application No. 2022-184614, filed on Nov. 18, 2022, the disclosure of which is incorporated herein in its entirety by reference.

### TECHNICAL FIELD

The present invention relates to a processing apparatus, a processing method, and a program.

### BACKGROUND ART

Techniques related to the present invention are disclosed in Patent Documents 1 to 3.
Patent Document 1 (Japanese Patent Application Publication No. 2018-142137) discloses a technique for detecting a person to be determined (a suspicious person or the like) in an image, based on feature information (age, gender, a body shape, a motion, clothing, a belonging, and/or the like) other than a face image.
Patent Document 2 (Japanese Patent Application Publication No. 2022-086627) discloses a technique for detecting a suspicious person or a suspicious object in an image, based on behavior or a feature of a person or an object.
Patent Document 3 (International Patent Publication No. WO2018/003148) discloses a technique for generating, in a virtual space, a three-dimensional image of an object and a model of a person who handles the object.

### DISCLOSURE OF THE INVENTION

When an incident or accident occurs, an involved person (a culprit or the like) is unknown in some cases. In such a case, various types of estimation concerning the involved person are made from witness information, a past similar case, and/or the like. For example, the an involved person in the current incident or accident is narrowed down from among involved persons in the past similar cases. In addition, for example, a feature (gender, an age group, a physique, and/or the like) of the involved person in the current incident or accident is computed based on the witness information, the past similar case, and/or the like.

In recent years, a computer has started to be used in the above-described various types of estimation. On the other hand, there is a case in which the above-described various types of estimation are performed based on intuition, experience, and/or the like of a human being.

Incidentally, when results of the above-described various types of estimation are mistakes, there can occur an inconvenience such as a mistaken arrest or an inability to find the involved person no matter how much time passes. Thus, a technique for deciding validity of results of the above-described various types of estimation is desired.

The techniques disclosed in Patent Documents 1 and 2 are techniques for detecting a suspicious person from within an image. The technique disclosed in Patent Document 3 is a technique for generating, in a virtual space, a three-dimensional image of an object and a model of a person who handles the object. These techniques cannot decide validity of results of the above-described various types of estimation.

In view of the above-described problem, one example of objects of the present invention is to provide a processing apparatus, a processing method, and a program that solve a problem of deciding validity of results of various types of estimation concerning an involved person in an incident or accident.

According to one aspect of the present invention, there is provided a processing apparatus including:
a site situation information acquisition unit that acquires site situation information indicating a situation of a site;
an involved person estimation unit that estimates, based on the site situation information, a feature of an involved person of an event that occurred at the site;
a computation unit that computes a feature difference being a difference between the estimated feature of the involved person and a feature of a target person; and
an output unit that outputs the feature difference.

According to one aspect of the present invention, there is provided a processing method including,
by at least one computer:
acquiring site situation information indicating a situation of a site;
estimating, based on the site situation information, a feature of an involved person of an event that occurred at the site;
computing a feature difference being a difference between the estimated feature of the involved person and a feature of a target person; and
outputting the feature difference.

According to one aspect of the present invention, there is provided a program causing a computer to function as:
a site situation information acquisition unit that acquires site situation information indicating a situation of a site;
an involved person estimation unit that estimates, based on the site situation information, a feature of an involved person of an event that occurred at the site;
a computation unit that computes a feature difference being a difference between the estimated feature of the involved person and a feature of a target person; and
an output unit that outputs the feature difference.

According to one aspect of the present invention, the processing apparatus, the processing method, and the program that solve a problem of deciding validity of results of various types of estimation concerning an involved person in an incident or accident can be implemented.

### BRIEF DESCRIPTION OF THE DRAWINGS

The above-described object, other objects, and features and advantages will become more apparent from the following preferred example embodiments and the following drawings associated therewith.

FIG. 1 is a diagram illustrating one example of a functional block diagram of a processing apparatus.

FIG. 2 is a diagram for illustrating an outline of one example of processing performed by the processing apparatus.

FIG. 3 is a diagram illustrating one example of a hardware configuration of the processing apparatus.

FIG. 4 is a diagram illustrating another example of a functional block diagram of the processing apparatus.

FIG. 5 is a diagram illustrating one example of a screen output by the processing apparatus

FIG. 6 is a flowchart illustrating one example of a flow of processing of the processing apparatus.

FIG. 7 is a diagram for illustrating an outline of one example of processing performed by the processing apparatus

FIG. 8 is a diagram illustrating one example of a functional block diagram of the processing apparatus.

FIG. 9 is a diagram illustrating one example of a screen output by the processing apparatus.

FIG. 10 is a flowchart illustrating one example of a flow of processing of the processing apparatus.

### DESCRIPTION OF EMBODIMENTS

Hereinafter, example embodiments of the present invention will be described with reference to the drawings. Note that, similar constituent elements are denoted by similar reference signs in all the drawings, and description thereof will be appropriately omitted.

### First Example Embodiment

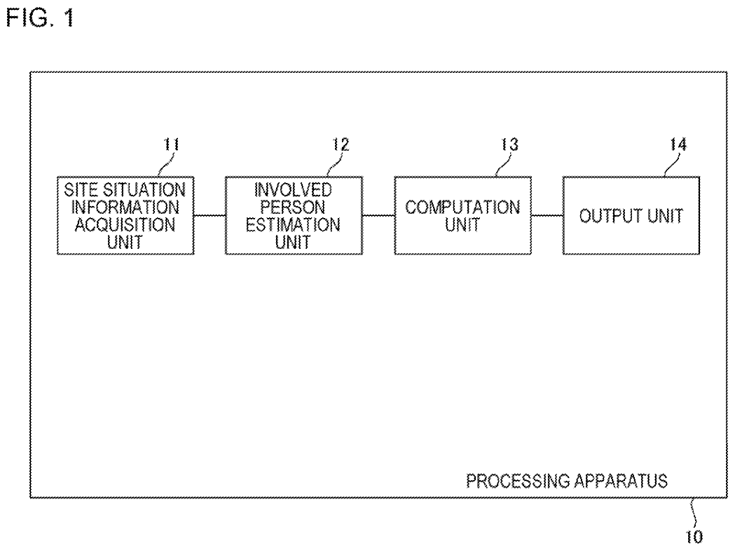

FIG. 1 is a functional block diagram illustrating an outline of a processing apparatus 10 according to a first example embodiment. The processing apparatus 10 includes a cite situation information acquisition unit 11, an involved person estimation unit 12, a computation unit 13, and an output unit 14.

The site situation information acquisition unit 11 acquires site situation information that indicates a situation of a site. The involved person estimation unit 12 estimates, based on the site situation information, a feature of an involved person of an event that occurred at the site. The computation unit 13 computes a feature difference that is a difference between the estimated feature of the involved person and a feature of a target person. The output unit 14 outputs the feature difference.

The target person is a person who is considered as an involved person of the event that occurred at the site. The involved person is a culprit, a suspects, a reference person, a victim, a perpetrator, a witness, or the like of the event that occurred at the site. The target person is a person who is decided, based on witness information, a past similar case, and/or the like, by an arbitrary method, as an involved person of the event that occurred at the site. The target person is not limited to a person, and may be an animal such as a bear, a dog, or a wild boar, or another living creature that is, for example, a bird such as a crow.

According to such a processing apparatus 10 of the present example embodiment, a difference between a feature of an involved person computed based on a situation of a site and a feature of a target person considered as an involved person of an event that occurred at the site is computed, and the computed difference can be output. The output difference indicates validity of decision that the target person is regarded as the involved person of the event that occurred at the site. As the difference is smaller, the decision is more valid.

According to such a processing apparatus 10 of the present example embodiment, the problem of deciding validity of results of various types of estimation concerning an involved person in an incident or accident is solved.

### Second Example Embodiment

### “Outline”

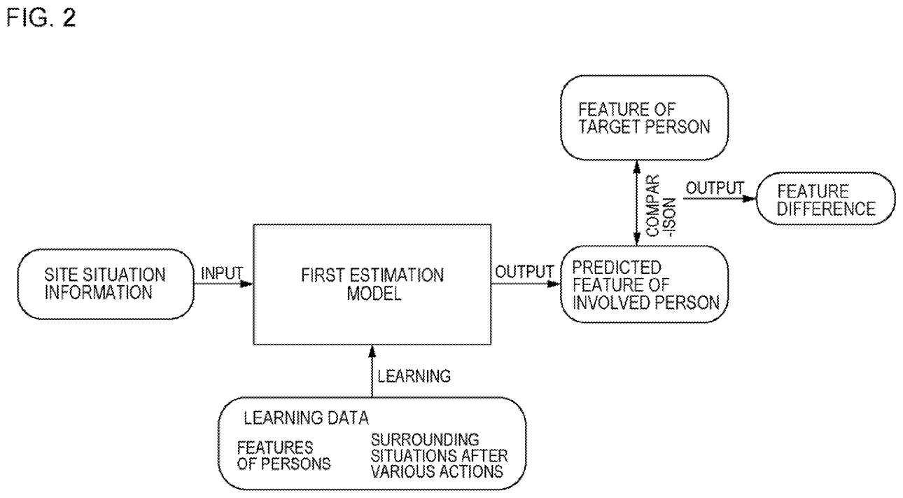

The processing apparatus 10 according to the present example embodiment is an embodied one of the processing apparatus 10 according to the first example embodiment. An outline of processing executed by the processing apparatus 10 will be described with reference to FIG. 2. Note that, details of each piece of the processing will be described later.

First, in the present example embodiment, a first estimation model is prepared. The first estimation model is generated by learning based on learning data in which a feature of a person is associated with a surrounding situation after each person performs various actions. The first estimation model receives an input of information indicating a situation, and outputs a feature of a person who causes such a situation.

The processing apparatus 10 inputs “site situation information indicating a situation of a site” to the first estimation model. Then, the processing apparatus 10 acquires, as a predicted feature of an involved person, “a feature of a person who causes such a situation of the site” output from the first estimation model.

Next, the processing apparatus 10 computes and outputs a difference (feature difference) between the acquired predicted feature of the involved person and a feature of the target person. The target person is a person who is considered as an involved person of the event that occurred at the site, as described above. Hereinafter, a configuration of such a processing apparatus 10 will be described in detail.

### “Hardware Configuration”

Next, one example of a hardware configuration of the processing apparatus 10 will be described. Each function unit of the processing apparatus 10 is implemented by arbitrary combination of hardware and software. It is understood by those skilled in the art that there are various modifications for an implementation method and an apparatus thereof. Examples of the software include a program stored in advance at a stage of shipping the apparatus, and a program downloaded from a storage medium such as a compact disc (CD), a server on the Internet, or the like.

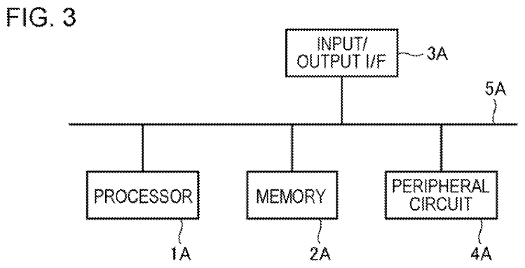

FIG. 3 is a block diagram illustrating the hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 does not need to include the peripheral circuit 4A. Note that, the processing apparatus 10 may be constituted of a plurality of physically and/or logically separated apparatuses. In this case, each of a plurality of the apparatuses can include the above-described hardware configuration.

The bus 5A is a data transmission path for the processor 1A, the memory 2A, the peripheral circuit 4A, and the input/output interface 3A to mutually transmit and receive data. The processor 1A is an arithmetic processing apparatus such as a CPU or a graphics processing unit (GPU). The memory 2A is a memory such as a random access memory (RAM) or a read only memory (ROM). The input/output interface 3A includes an interface for acquiring information from an input apparatus, an external apparatus, an external server, an external sensor, a camera, and/or the like, and an interface for outputting information to an output apparatus, an external apparatus, an external server, and/or the like. In addition, the input/output interface 3A includes an interface for connecting to a communication network such as the Internet. The input apparatus includes a keyboard, a mouse, a microphone, a physical button, a touch panel, and/or the like. The output apparatus includes a display, a speaker, a printer, a mailer, and/or the like. The processor 1A can output a command to each module, and based on results of arithmetic operation thereof, the processor 1A can perform arithmetic operation.

### “Functional Configuration”

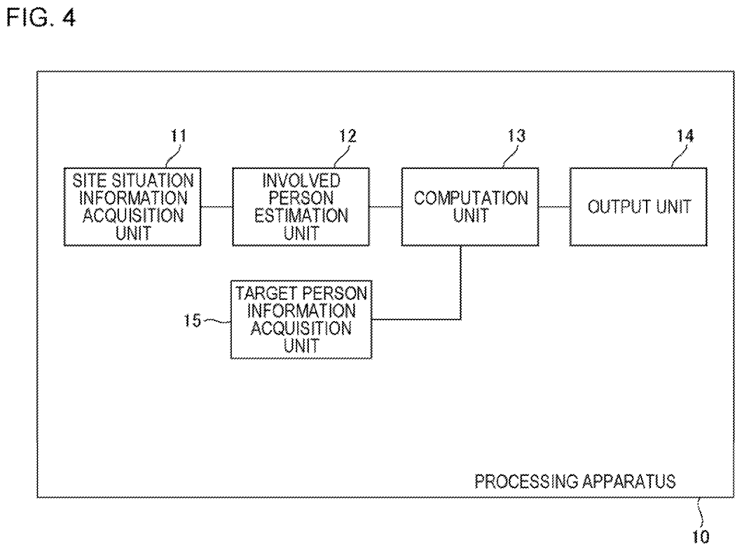

Next, a functional configuration of the processing apparatus 10 according to the present example embodiment will be described in detail. FIG. 4 illustrates one example of a functional block diagram of the processing apparatus 10. As illustrated in the drawing, the processing apparatus 10 includes the site situation information acquisition unit 11, the involved person estimation unit 12, the computation unit 13, the output unit 14, and a target person information acquisition unit 15.

The site situation information acquisition unit 11 acquires site situation information that indicates a situation of a site.

The “site” is a site where an incident or accident occurred. For example, the processing apparatus 10 according to the present example embodiment is used at a site for which an involved person is unknown. Types of an incident and an accident include an assault, an injury, murder, a robbery, property damage, a traffic accident, damage by an animal, and falling of an object, for example, but are not limited to these,

The “site situation information” includes at least one of a captured image of the site (including at least one of a still image and a moving image), an illustration depicting a situation of the site, and a text depicting a situation of the site. The images and the illustration may be three-dimensional (3D) information or two-dimensional (2D) information. For example, a police officer or the like inspects the site, and generates the site situation information.

The site situation information indicates a situation of the site. The site situation information preferably includes any situation whose content can vary depending on a feature of a person who caused the situation. For example, when an object is broken, the site situation information indicates the broken condition (e.g., a size of a broken part, a position of the broken part, and a broken degree, and/or the like). The object may be an object that constantly existed at the site and whose examples include a utility pole, a signboard, a desk, a bookshelf, a table, and a television. In addition, the object may be a portable object such as a bag, a stick, or a weapon. When a liquid, a splash of water, pieces of glass, or the like is spattered, the site situation information indicates a position and a spattered degree (e.g., a spattered distance, a spattered direction, and/or the like) thereof. Note that, there is no limitation to a liquid, a splash of water, and pieces of glass, and thus, these may be replaced by bloodstain and a splash of blood may replace these. When a constructed object such as a wall or a roof is broken, a position, a size, a broken degree, and/or the like thereof is indicated. When there are other creatures caught in the incident or accident, their states may be indicated. Examples of other creatures include animals such as a bear, a dog, and a wild boar, and birds such as a crow.

The site situation information may include environmental information (e.g., weather, a temperature, humidity, a time zone, a season, and/or the like) at a timing (estimated timing) that the event occurred. In addition, the site situation information may include position information (e.g., latitude and longitude information, an area name, an address, a front to a traffic light, and/or the like) of the site, date and time information of an incident or accident, a testimony of a witness, and/or the like. The site situation information may indicate an object (e.g., a weapon, furniture, an electric appliance, and/or the like) existing at the site.

In the present example embodiment, “acquisition” includes at least one of: “to take out, by the self-apparatus, data or information stored in another apparatus or storage medium (active acquisition)”; and “to input, to the self-apparatus, data or information output from another apparatus (passive acquisition). Examples of the active acquisition include: making a request or an inquiry to another apparatus and thereby receiving a reply thereto; and accessing another apparatus or storage medium and thereby making reading-out.

Examples of the passive acquisition include receiving information delivered (or transmitted, or for which push notification is made, for example). Further, “acquisition” may be selecting and acquiring from received data or information, or selecting and receiving delivered data or information.

Based on the site situation information acquired by the site situation information acquisition unit 11, the involved person estimation unit 12 estimates a feature of an involved person of an event that occurred at the site.

The “event that occurred at the site” is the above-described incident or accident.

The “involved person” is a person involved in the event, and is, for example, a culprit, a suspect, a reference person, a victim, a perpetrator, a witness, or the like of the event.

The “feature of an involved person” includes at least one of race, nationality, culture, religion, age, gender, a height, a weight, a lung capacity, a body fat percentage, a limb length, a limb weight, a dominant hand, a dominant foot, and clothing (e.g., pants, a skirt, tight clothing, loose clothing, and/or the like).

The involved person estimation unit 12 estimates the feature of the involved person by using a first estimation model illustrated in FIG. 2.

The first estimation model is generated by learning based on learning data that indicate surrounding situations after persons having various features perform various actions. As illustrated in FIG. 2, the learning data are data in which the features of the persons are associated with the surrounding situations after the respective persons perform the various actions.

The first estimation model receives an input of information indicating a situation, and outputs a feature of a person who causes such a situation. The involved person estimation unit 12 inputs “the site situation information indicating a site situation” to the first estimation model. Then, the involved person estimation unit 12 acquires, as a predicted feature of the involved person, “a feature of a person who causes such a situation at the site” output from the first estimation model.

A feature of a person indicated by the learning data includes at least one of race, nationality, culture, religion, age, gender, a height, a weight, a lung capacity, a body fat percentage, a limb length, a limb weight, a dominant hand, a dominant foot, and clothing.

Various actions are actions that involved persons can perform in various incidents and accidents. The following indicates one example of such actions, but there is no limitation to these.
Pushing target objects (e.g., an object (doll or the like) likened to a person, and other objects) with bare hands
Pushing target objects with various objects (e.g., a stick, and the like)
Hitting target objects with bare hands
Hitting target objects with various objects
Striking target objects with bare hands
Striking target objects with various objects
Kicking target objects
Hurling away target objects
Stabbing target objects with various edged tools (having blade lengths of 5 cm, 10 cm, and the like)
Shooting target objects
Throwing various objects at target objects

These actions are preferably performed under various conditions different from each other. Thereby, variations of the learning data are increased. Various conditions may be defined by environmental conditions such as weather, a temperature, humidity, a time zone, and a season. Various conditions may be defined by states of a person who performs an action. For example, the condition may be defined as time of being tired (e.g., after running 50 m, after running 100 m, after running 500 m, after shadow boxing for 1 minute, or the like), or as normal time, for example. In addition, the condition may be defined as a state in which momentum is gained by running, or a state in which momentum is not gained, for example.

A plurality of persons participate in generation of the learning data. Then, the above-described feature of each person is determined. Each person performs the above-described action. Note that, each person may perform each action once or a plurality of times. Then, information that indicates a surrounding situation, specifically a state of a target object and the derivatives (e.g., a liquid or a water splash, glass fragments, a bloodstain or splattered blood, or the like attached to the surrounding ground, wall, or target object) after each person performs each action is collected. The information includes at least one of a captured image (including at least one of a still image and a moving image) of the surrounding situation, an illustration depicting the surrounding situation, and a text depicting the surrounding situation. The image and the illustration may be 3D information or 2D information.

The target person information acquisition unit 15 acquires target person information that indicates a feature of a target person. A user inputs the target person information to the processing apparatus 10. The target person information acquisition unit 15 acquires the target person information input by the user. Concerning a means for receiving the input from the user, there is no particularly limitation, and any technique can be adopted.

The “target person information” is information indicating a feature of a person considered as an involved person of the event that occurred at the site. For example, the target person information can include at least one of the following features of a person.
A feature of a person arrested in connection with the event that occurred at the site
A feature of a suspect of the event that occurred at the site
A feature of a reference person of the event that occurred at the site
A feature of a victim of the event that occurred at the site
A feature of a perpetrator of the event that occurred at the site
A feature of a witness of the event that occurred at the site
A feature of a person indicated by witness information collected in connection with the event that occurred at the site

The “a feature of a target person” includes at least one of race, nationality, culture, religion, age, gender, a height, a weight, a lung capacity, a body fat percentage, a limb length, a limb weight, a dominant hand, a dominant foot, and clothing.

The computation unit 13 computes a feature difference that is a difference between the feature of the involved person estimated by the involved person estimation unit 12 and the feature of the target person acquired by the target person information acquisition unit 15.

The feature of the target person for which the difference is computed includes at least one of race, nationality, culture, religion, age, gender, a height, a weight, a lung capacity, a body fat percentage, a limb length, a limb weight, a dominant hand, a dominant foot, and clothing, for example.

For each of these items, the computation unit 13 decides whether the feature of the involved person estimated by the involved person estimation unit 12 matches the feature of the target person acquired by the target person information acquisition unit 15. Then, the computation unit 13 determines the difference items as feature differences.

In addition, for the item represented by a numerical value such as a height, a weight, a lung capacity, a body fat percentage, a limb length, and a limb weight, the computation unit 13 computes, as the feature difference, a difference between a numerical value of the feature of the involved person estimated by the involved person estimation unit 12 and a numerical value of the feature of the target person acquired by the target person information acquisition unit 15.

The output unit 14 generates information indicating the feature difference computed by the computation unit 13, and outputs the information by an arbitrary means. The output unit 14 can output the information indicating the feature difference, via various output apparatuses such as a display, a projection apparatus, and a printer.

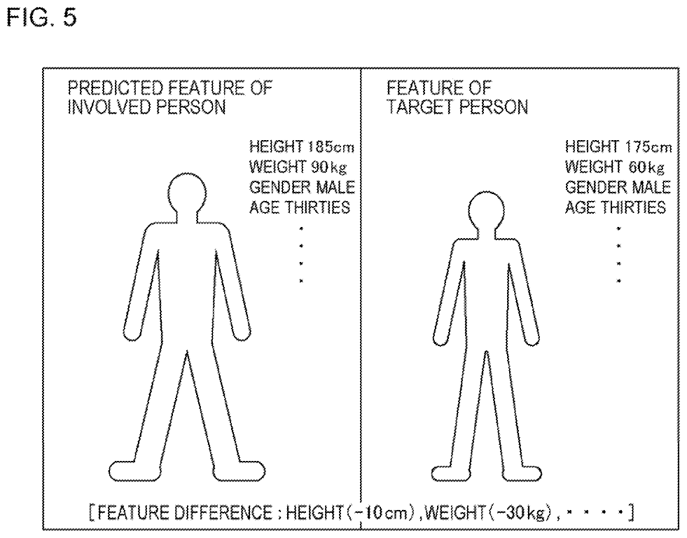

For example, the output unit 14 may generate and output a screen as illustrated in FIG. 5. In the screen illustrated in FIG. 5, a feature (“predicted feature of involved person” in the drawing) of an involved person estimated by the involves person estimation unit 12 and a feature (“feature of target person” in the drawing) of a target person acquired by the target person information acquisition unit 15 are displayed side by side. In addition, person models having respective features are generated by using a technique such as computer graphics, and are displayed side by side. The person models may be 3D images or 2D images.

In the screen illustrated in FIG. 5, the feature difference computed by the computation unit 13 is displayed. The feature difference indicates the item for which a mutual difference exists. In addition, the feature difference indicates a difference between numerical values of the item for which a mutual difference exists. FIG. 5 illustrates that a mutual difference exists in a height and a weight.

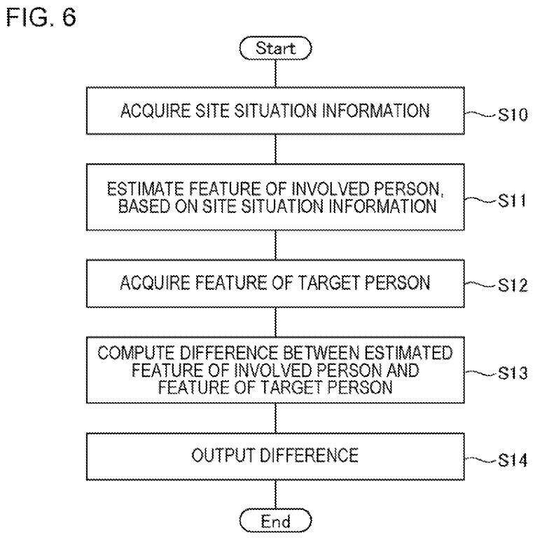

Next, one example of a flow of processing of the processing apparatus 10 will be described with reference to a flowchart of FIG. 6.

When the processing apparatus 10 acquires the site situation information indicating a site situation (S10), the processing apparatus 10 estimates, based on the site situation information, a feature of an involved person of an event that occurred at a site (S11). Next, the processing apparatus 10 acquires a feature of a target person (S12). Note that, the processing turn of S12 is not limited to the illustrated one. The step S12 may be performed in parallel with S10 and S11, or may be performed before S10 and S11.

Next, the processing apparatus 10 computes a feature difference that is a difference between the feature of the involved person estimated at S11 and the feature of the target person acquired at S12 (S13). Then, the processing apparatus 10 outputs the feature difference computed at S13 (S14).

### Advantageous Effects

The processing apparatus 10 according to the present example embodiment achieves the advantageous effect similar to that of the processing apparatus 10 according to the first example embodiment.

In addition, after the processing apparatus 10 according to the present example embodiment estimates a feature of an involved person from the site situation information, the processing apparatus 10 computes a feature difference that is a difference between the estimated feature of the involved person and a feature of a target person, and can output the computed feature difference.

A user inputs, to the processing apparatus 10, as the feature of the target person, a feature of each person considered as an involved person of an event that occurred at a site, and can thereby recognize validity of decision that each of the persons is regarded as an involved person of the event that occurred at the site. The output feature difference indicates the validity of the decision. As the feature difference is smaller, the decision is more valid.

The police or the like can conduct an operation such as investigation by using a decision result of the processing apparatus 10 as objective evidence. As a result, fair investigation that is not based on subjectivity can be implemented.

### Third Example Embodiment

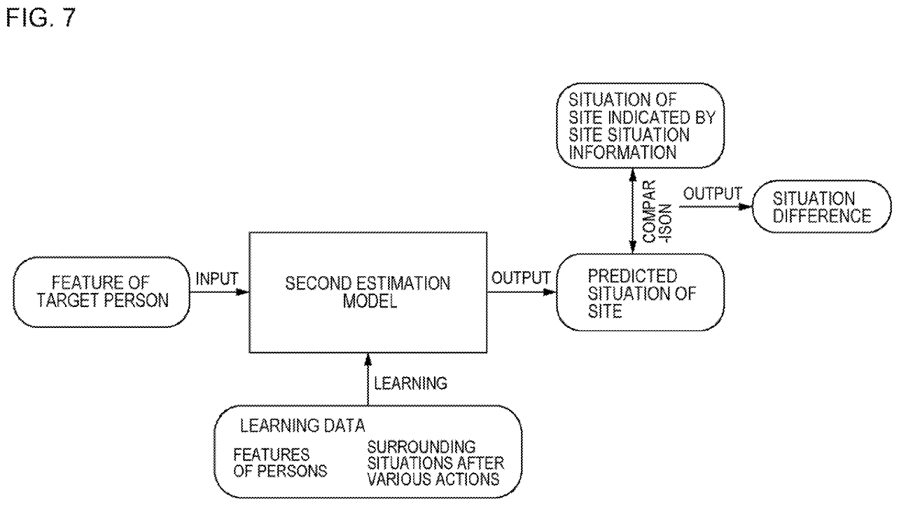

An outline of processing executed by the processing apparatus 10 will be described with reference to FIG. 7. Note that, details of each piece of the processing will be described later.

First, in the present example embodiment, a second estimation model is prepared. The second estimation model is generated by learning based on learning data in which features of persons are associated with surrounding situations after respective persons perform the various actions. The second estimation model receives an input of a feature of a person, and outputs a situation caused by such a person.

The processing apparatus 10 inputs “a feature of a target person” to the second estimation model. As described above, the target person is a person considered as an involved person of an event that occurred at a site. Then, the processing apparatus 10 acquires “a situation of the site caused by such a person” output from the second estimation model.

Next, the processing apparatus 10 computes and outputs a difference (situation difference) between the prediction of a situation of the site caused by the target person and a situation of the site indicated by the site situation information. Hereinafter, a configuration of such a processing apparatus 10 will be described in detail.

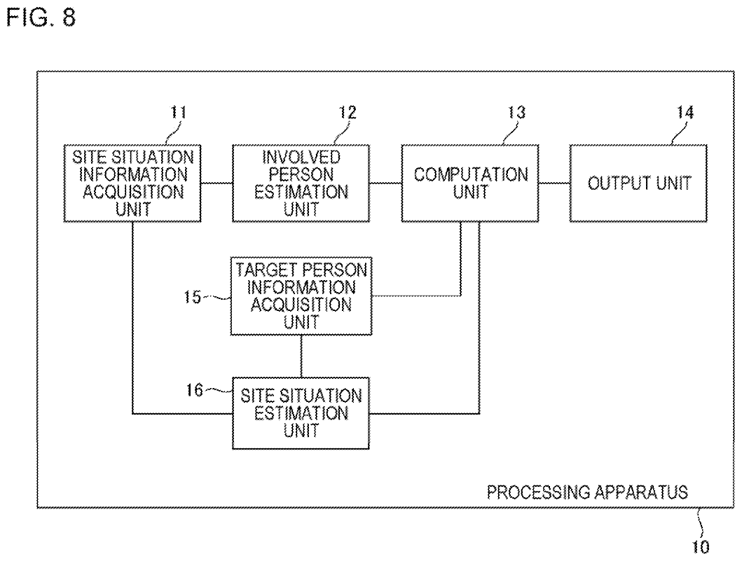

FIG. 8 illustrates one example of a functional block diagram of the processing apparatus 10. As illustrated in the drawing. the processing apparatus 10 includes the site situation information acquisition unit 11, the involved person estimation unit 12, the computation unit 13, the output unit 14, the target person information acquisition unit 15, and a site situation estimation unit 16.

Based on a feature of a target person indicated by the target person information acquired by the target person information acquisition unit 15, the site situation estimation unit 16 estimates a situation of a site when the target person is assumed to be an involved person of an event that occurred at the site.

The site situation estimation unit 16 uses the second estimation model illustrated in FIG. 7, and thereby estimates the situation of the site when the target person is assumed to be an involved person of the event that occurred at the site.

The second estimation model is generated by learning based on learning data that indicate surrounding situations after persons having various features perform various actions. As illustrated in FIG. 2, the learning data are data in which features of the persons are associated with the surrounding situations after the respective persons perform various actions.

The second estimation model receives an input of a feature of a person, and outputs a surrounding situation (a situation of a site) caused by a person having such a feature. The site situation estimation unit 16 inputs “the feature of the target person” to the second estimation model. Then, the site situation estimation unit 16 acquires “the situation of the site caused by such a person” output from the second estimation model.

The content output from the second estimation model includes, for example, a state (e.g., a size of a broken part, a position of the broken part, a broken degree, and/or the like) of a target object (e.g., an object (doll or the like) likened to a person, or another object), a state (e.g., a spattered distance, a spattered direction, and/or the like) of the derivatives (e.g., a liquid, a water splash, glass fragments, a bloodstain, or splattered blood, and/or the like attached to the surrounding ground, wall, and/or target object), and/or a state (a broken position and/or size, a broken degree, and/or the like) of a constructed object such as a wall or a roof.

The content and an acquisition method of the learning data are similar to the content and the acquisition method of the learning data for the first estimation model described in the second example embodiment.

The computation unit 13 computes a situation difference that is a difference between the situation of the site estimated by the site situation estimation unit 16 and a situation of the site indicated by the site situation information acquired by the site situation information acquisition unit 11.

For example, the computation unit 13 may compute, as the situation difference, a difference in a spattered distance of a liquid, a water splash, glass fragments, a bloodstain, splattered blood, or the like. The spattered distances of these may be each defined as a distance from a gathered liquid or the like formed on a floor, for example, or may be defined by other methods. In addition, the computation unit 13 may compute, as the situation difference, a difference in a broken position of a target object, a difference in a size of a broken part, or the like.

The output unit 14 generates information indicating the situation difference computed by the computation unit 13, and outputs the information by an arbitrary means. The output unit 14 can output the information indicating the situation difference, via various output apparatuses such as a display, a projection apparatus, and a printer.

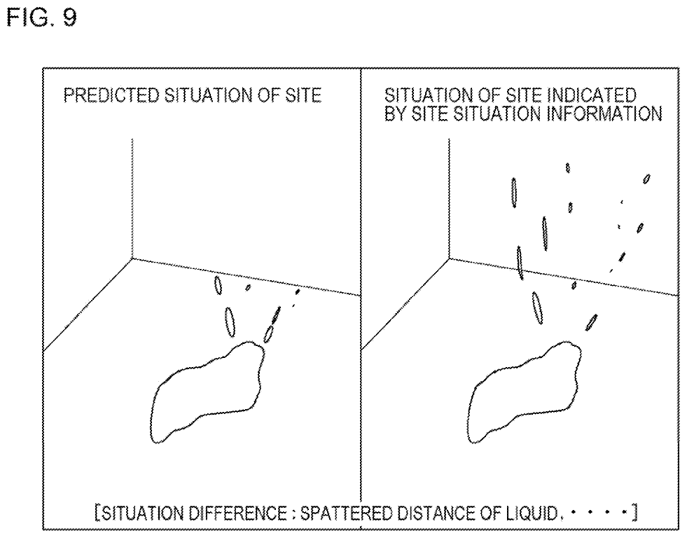

For example, the output unit 14 may generate and output a screen as illustrated in FIG. 9. On the screen illustrated in FIG. 9, the situation (“predicted situation of site” in the drawing) of the site estimated by the site situation estimation unit 16, and the situation (“situation of site indicated by site situation information” in the drawing) of the site indicated by the site situation information acquired by the site situation information acquisition unit 11 are displayed side by side. Each of the scenes is a model image of the site generated by using a technique such as computer graphics. The model image of the site may be a 3D image or a 2D image.

In addition, on the screen illustrated in FIG. 9, the situation difference computed by the computation unit 13 is displayed. The situation difference indicates the item for which a mutual difference exists. FIG. 9 illustrates that a mutual difference exists in a spattered distance of a liquid.

The model image of “situation of site indicated by site situation information” illustrated on the right side in FIG. 9 is generated by reproducing the situation of the site indicated by the site situation information. The model image of “situation of site indicated by site situation information” may be automatically generated by a computer, based on the site situation information, or may be generated based on an operation of an operator. For example, a space is first generated, various objects (e.g., a liquid, a weapon, furniture, a plant, and/or the like) are then arranged in the space, and the model image is thereby generated. A size and a shape of the space, sizes, shapes, positions in the space, and orientations of the various objects, and the like are indicated by the site situation information. Space data accumulated from past incidents or accidents, sample data accumulated by an arbitrary means, and/or the like may be used for generating the space.

On the other hand, the model image of “predicted situation of site” illustrated on the left side in FIG. 9 may be generated by altering the model image of “situation of site indicated by site situation information” illustrated on the right side in FIG. 9. A difference indicated as the situation difference is a target of the altering. In other words, the content (e.g., the spattered distance of the liquid) of an object indicated as the situation difference in the model image of “situation of site indicated by site situation information” may be altered to the content estimated by the site situation estimation unit 16, and thereby, the model image of “predicted situation of site” may be generated.

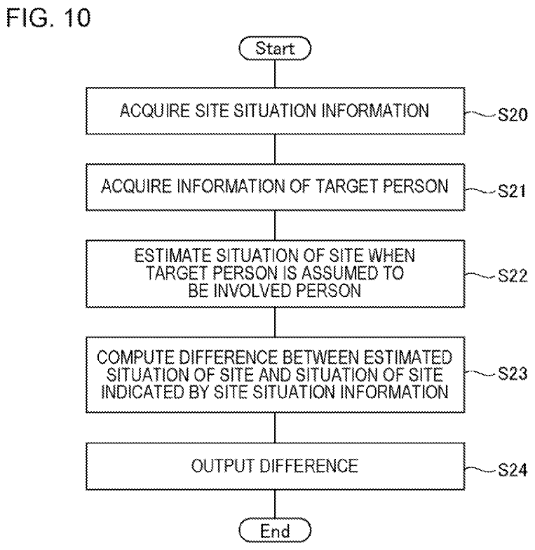

Next, one example of a flow of processing of the processing apparatus 10 will be described with reference to a flowchart of FIG. 10.

The processing apparatus 10 acquires the site situation information indicating a situation of a site (S20). In addition, the processing apparatus 10 acquires information indicating a feature of a target person (S21). Note that, S21 may be performed in parallel with S20, or may be performed before S20.

Next, based on the feature of the target person, the processing apparatus 10 estimates a situation of the site when the target person is assumed to be an involved person of an event that occurred at the site (S22).

Next, the processing apparatus 10 computes a situation difference that is a difference between the situation of the site estimated at S22 and the situation of the site indicated by the site situation information acquired at S20 (S23). Then, the processing apparatus 10 outputs the situation difference computed at S23 (S24).

Other configurations of the processing apparatus 10 are similar to those in the first and second example embodiments. In other words, the processing apparatus 10 according to the example embodiment is configured in such a way as to execute both the processing illustrated in FIG. 2 and using the first estimation model and the processing illustrated in FIG. 7 and using the second estimation model. In a modified example, the processing apparatus 10 according to the present example embodiment may be configured in such a way as to execute only the processing illustrated in FIG. 7 and using the second estimation model and as not to execute the processing illustrated in FIG. 2 and using the first estimation model.

According to the processing apparatus 10 of the present example embodiment, advantageous effects similar to those in the first and second example embodiments are achieved. In addition, according to the processing apparatus 10 of the present example embodiment, a difference (situation difference) between a prediction of a situation of a site caused by a target person considered as an involved person of an event that occurred at the site and a situation of the site indicated by the site situation information can be computed and output.

A user inputs, to the processing apparatus 10, a feature of a target person considered as an involved person of an event that occurred at a site, and can thereby recognize validity of decision that the target person is regarded as the involved person of the event that occurred at the site. The output situation difference indicates the validity of the decision. As the situation difference is smaller, the decision is more valid.

The police or the like can conduct an operation such as investigation by using a decision result of the processing apparatus 10 as objective evidence. As a result, fair investigation that is not based on subjectivity can be implemented.

### Modified Example

Hereinafter, modified examples applicable to the first to third example embodiments will be described. The modified examples also achieve advantageous effects similar to those in the first to third example embodiments.

### Modified Example 1

When the processing apparatus 10 inputs “the site situation information indicating a situation of a site” to the first estimation model, and acquires “a feature of a person who causes such a situation of the site” output from the first estimation model as described in the second example embodiment (refer to FIG. 2), the processing apparatus 10 may output the acquired result of “the feature of the person who causes such a situation of the site” to a user. In this case, for example, only the information of “predicted feature of involved person” in FIG. 5 is provided to the user.

Based on the information, the user can narrow down culprits, suspects, reference persons, victims, perpetrators, witnesses, and/or the like, or search for a culprit, a suspect, a reference persons, a victim, a perpetrator, a witness, and/or the like.

### Modified Example 2

The involved person estimation unit 12 of the processing apparatus 10 may estimate a feature of a person who cannot cause a situation of a site indicated by the site situation information. Then, the output unit 14 may provide (output), to a user, the feature of the person who cannot cause the situation of the site indicated by the site situation information.

There are various methods for the estimation. For example, the involved person estimation unit 12 may estimate that a feature of a person inapplicable to “a feature of a person who causes the situation of the site indicated by the site situation information” output by the first estimation model is the feature of the person who cannot cause the situation of the site indicated by the site situation information.

In addition, the involved person estimation unit 12 may input, to the second estimation model described in the third example embodiment, a feature of a person inapplicable to “a feature of a person who causes the situation of the site indicated by the site situation information”, and acquire a prediction of a situation of the site that can be caused by a person having such a feature. Then, when the prediction of a situation of the site and a situation of the site indicated by the site situation information differ by at least a predetermined level from each other, the involved person estimation unit 12 may estimate that a feature of such a person is a feature of a person who cannot cause the situation of the site indicated by the site situation information.

The above-described “differ by at least a predetermined level” may mean “differ in a spattered distance of a liquid or the like by at least a threshold value”, for example, or may mean “differ from each other in at least a predetermined ratio of items to (or at least a predetermined number of items among) a plurality of items that indicate the situation of the site”, or may have another meaning.

### Modified Example 3

The processing apparatus 10 may generate an image (still image or moving image) reproducing a scene at a site, and provide the generated image to a user. For example, the processing apparatus 10 may reproduce the scene at the site by arranging, in a model image (refer to the right side in FIG. 9) of “a situation of the sire indicated by the site situation information” generated by the method described in the third example embodiment, an image (refer to the left side in FIG. 5) of a person model of “a predicted feature of an involved person” generated by the method described in the second example embodiment.

In a case of generating a moving image, a user inputs, to the processing apparatus 10, an action that the person model is caused to perform. Then, the processing apparatus 10 generates a moving image in which the person model arranged in the model image is caused to perform the action specified by the user. Examples of the action that the person model can be caused to perform include pushing, hitting, striking, kicking, hurling away, stabbing with an edged tool, shooting, and throwing an object, but the action is not limited to these. Note that, these actions may have variations performed under various emotions. Such examples include pressing in a state of rage, and pressing in a calm state.

The user visually recognizes a site situation, based on the reproduced image, and can thereby take various perceptions.

Although the example embodiments of the present invention are described above with reference to the drawings, these are exemplifications of the present invention, and various configurations other than those described above can also be adopted. The configurations of the above-described example embodiments may be combined with each other, or a part of the configurations may be replaced with another or others of the configurations. In addition, the configurations of the above-described example embodiments may be variously modified within a range that does not depart from the essence of the present invention. Further, the configurations and pieces of the processing disclosed in the above-described example embodiments and modified examples may be combined with each other.

In addition, in a plurality of the flowcharts used in the above description, a plurality of the steps (pieces of processing) are described in order, but the execution order of the steps executed in each example embodiment is not limited to the described order. In each example embodiment, the order of the illustrated steps can be changed within a range in which inconvenience does not occur in the content. The above-described each example embodiment can be combined within a range in which contradiction does not occur in the content.

A part or all of the above-described example embodiments can also be described as in the following supplementary notes, but there is no limitation to the following.
1. A processing apparatus including:
   a site situation information acquisition unit that acquires site situation information indicating a situation of a site;
   an involved person estimation unit that estimates, based on the site situation information, a feature of an involved person of an event that occurred at the site;
   a computation unit that computes a feature difference being a difference between the estimated feature of the involved person and a feature of a target person; and
   an output unit that outputs the feature difference.
2. The processing apparatus according to the supplementary note 1, wherein
   the feature of the target person includes at least one of a feature of a person arrested in connection with the event that occurred at the site, a feature of a suspect of the event that occurred at the site, a feature of a reference person of the event that occurred at the site, and a feature of a person indicated by witness information collected in connection with the event that occurred at the site.
3. The processing apparatus according to the supplementary note 1 or 2, wherein
   the feature of the involved person and the feature of the target person include at least one of race, nationality, culture, religion, age, gender, a height, a weight, a lung capacity, a body fat percentage, a limb length, a limb weight, a dominant hand, a dominant foot, and clothing.
4. The processing apparatus according to any one of the supplementary notes 1 to 3, wherein
   the site situation information includes at least one of a captured image of the site, an illustration depicting a situation of the site, and a text depicting a situation of the site.
5. The processing apparatus according to any one of the supplementary notes 1 to 4, wherein
   the involved person estimation unit estimates the feature of the involved person, based on an estimation model generated based on learning data that indicate surrounding situations after a person having various features performs various actions.
6. The processing apparatus according to any one of the supplementary notes 1 to 5, further including
   a site situation estimation unit that estimates, based on the feature of the target person, a situation of the site when the target person is assumed to be an involved person of the event that occurred at the site, wherein
   the computation unit computes a situation difference being a difference between the estimated situation of the site and the situation of the site indicated by the site situation information, and
   the output unit outputs the situation difference.
7. The processing apparatus according to the supplementary note 6, wherein
   the site situation estimation unit estimates the situation of the site, based on an estimation model generated based on learning data that indicate surrounding situations after a person having various features performs various actions.
8. The processing apparatus according to any one of the supplementary notes 1 to 7, wherein
   the involved person estimation unit estimates a feature of a person who cannot cause a situation of a site indicated by the site situation information, and
   the output unit outputs a feature of a person who cannot cause a situation of a site indicated by the site situation information.
9. A processing method including,
   by at least one computer:
   acquiring site situation information indicating a situation of a site;
   estimating, based on the site situation information, a feature of an involved person of an event that occurred at the site;
   computing a feature difference being a difference between the estimated feature of the involved person and a feature of a target person; and
   outputting the feature difference.
10. A program causing a computer to function as:
   a site situation information acquisition unit that acquires site situation information indicating a situation of a site;
   an involved person estimation unit that estimates, based on the site situation information, a feature of an involved person of an event that occurred at the site;
   a computation unit that computes a feature difference being a difference between the estimated feature of the involved person and a feature of a target person; and
   an output unit that outputs the feature difference.
10 Processing apparatus
11 Site situation information acquisition unit
12 Involved person estimation unit
13 Computation unit
14 Output unit
15 Target person information acquisition unit
16 Site situation estimation unit
1A Processor
2A Memory
3A Input/output I/F
4A Peripheral circuit
5A Bus

1. A processing apparatus comprising:
at least one memory configured to store one or more instructions; and
at least one processor configured to execute the one or more instructions to:
acquire site situation information indicating a situation of a site;
estimate, based on the site situation information, a feature of an involved person of an event that occurred at the site;
compute a feature difference being a difference between the estimated feature of the involved person and a feature of a target person; and
output the feature difference.

2. The processing apparatus according to claim 1, wherein
the feature of the target person includes at least one of a feature of a person arrested in connection with the event that occurred at the site, a feature of a suspect of the event that occurred at the site, a feature of a reference person of the event that occurred at the site, and a feature of a person indicated by witness information collected in connection with the event that occurred at the site.

3. The processing apparatus according to claim 1, wherein
the feature of the involved person and the feature of the target person include at least one of race, nationality, culture, religion, age, gender, a height, a weight, a lung capacity, a body fat percentage, a limb length, a limb weight, a dominant hand, a dominant foot, and clothing.

4. The processing apparatus according to claim 1, wherein
the site situation information includes at least one of a captured image of the site, an illustration depicting a situation of the site, and a text depicting a situation of the site.

5. The processing apparatus according to claim 1, wherein
the processor is further configured to execute the one or more instructions to estimate the feature of the involved person, based on an estimation model generated based on learning data that indicate surrounding situations after a person having various features performs various actions.

6. The processing apparatus according to claim 1, wherein the processor is further configured to execute the one or more instructions to
estimate, based on the feature of the target person, a situation of the site when the target person is assumed to be an involved person of the event that occurred at the site,
compute a situation difference being a difference between the estimated situation of the site and the situation of the site indicated by the site situation information, and
output the situation difference.

7. The processing apparatus according to claim 6, wherein
the processor is further configured to execute the one or more instructions to estimate the situation of the site, based on an estimation model generated based on learning data that indicate surrounding situations after a person having various features performs various actions.

8. The processing apparatus according to claim 1, wherein the processor is further configured to execute the one or more instructions to
estimate a feature of a person who cannot cause a situation of a site indicated by the site situation information, and
output a feature of a person who cannot cause a situation of a site indicated by the site situation information.

9. A processing method comprising,
by at least one computer:
acquiring site situation information indicating a situation of a site;
estimating, based on the site situation information, a feature of an involved person of an event that occurred at the site;
computing a feature difference being a difference between the estimated feature of the involved person and a feature of a target person; and
outputting the feature difference.

10. The processing method according to claim 9, wherein
the feature of the target person includes at least one of a feature of a person arrested in connection with the event that occurred at the site, a feature of a suspect of the event that occurred at the site, a feature of a reference person of the event that occurred at the site, and a feature of a person indicated by witness information collected in connection with the event that occurred at the site.

11. The processing method according to claim 9, wherein
the feature of the involved person and the feature of the target person include at least one of race, nationality, culture, religion, age, gender, a height, a weight, a lung capacity, a body fat percentage, a limb length, a limb weight, a dominant hand, a dominant foot, and clothing.

12. The processing method according to claim 9, wherein
the site situation information includes at least one of a captured image of the site, an illustration depicting a situation of the site, and a text depicting a situation of the site.

13. The processing method according to claim 9, wherein
the at least one computer estimates the feature of the involved person, based on an estimation model generated based on learning data that indicate surrounding situations after a person having various features performs various actions.

14. The processing method according to claim 9, wherein the at least one computer
estimates, based on the feature of the target person, a situation of the site when the target person is assumed to be an involved person of the event that occurred at the site,
computes a situation difference being a difference between the estimated situation of the site and the situation of the site indicated by the site situation information, and
outputs the situation difference.

15. A non-transitory storage medium storing a program causing a computer to:
acquire site situation information indicating a situation of a site;
estimate, based on the site situation information, a feature of an involved person of an event that occurred at the site;
compute a feature difference being a difference between the estimated feature of the involved person and a feature of a target person; and
output the feature difference.

16. The non-transitory storage medium according to claim 15, wherein
the feature of the target person includes at least one of a feature of a person arrested in connection with the event that occurred at the site, a feature of a suspect of the event that occurred at the site, a feature of a reference person of the event that occurred at the site, and a feature of a person indicated by witness information collected in connection with the event that occurred at the site.

17. The non-transitory storage medium according to claim 15, wherein
the feature of the involved person and the feature of the target person include at least one of race, nationality, culture, religion, age, gender, a height, a weight, a lung capacity, a body fat percentage, a limb length, a limb weight, a dominant hand, a dominant foot, and clothing.

18. The non-transitory storage medium according to claim 15, wherein
the site situation information includes at least one of a captured image of the site, an illustration depicting a situation of the site, and a text depicting a situation of the site.

19. The non-transitory storage medium according to claim 15, wherein
the program causing the computer to estimate the feature of the involved person, based on an estimation model generated based on learning data that indicate surrounding situations after a person having various features performs various actions.

20. The non-transitory storage medium according to claim 15, wherein the program causing the computer to
estimate, based on the feature of the target person, a situation of the site when the target person is assumed to be an involved person of the event that occurred at the site,
compute a situation difference being a difference between the estimated situation of the site and the situation of the site indicated by the site situation information, and
output the situation difference.
